(19) United States
(12) Patent Application Publication
(10) Pub. No.: US 2025/0097793 A1
(43) Pub. Date: Mar. 20, 2025

(54) CELLS SHARING RRC LAYER

(71) Applicant: Nokia Technologies Oy, Espoo (FI)

(72) Inventors: Xin ZHANG, Taufkirchen (DE); Rakash SIVASIVA GANESAN, Aschaffenburg (DE); Aritra CHATTERJEE, Kolkata (IN); Marvin MANALASTAS, Bixby, OK (US); Srinivasan SELVAGANAPATHY, Bangalore (IN); Guillaume DECARREAU, Munich (DE); Hans Thomas HÖHNE, Helsinki (FI)

(21) Appl. No.: 18/883,788

(22) Filed: Sep. 12, 2024

(30) Foreign Application Priority Data
Sep. 15, 2023 (IN) 202341062266

(51) Int. Cl. H04W 36/00

(52) U.S. Cl. CPC H04W 36/0072; H04W 36/0058

(57) ABSTRACT

A method is disclosed comprising: transmitting, to a network entity, at least one measurement report, the network entity providing a serving cell and a target cell for the apparatus, wherein the serving cell and the target cell share at least a protocol configuration of a radio resource control layer; receiving, from the network entity an indication of a handover configuration for a handover of the apparatus to the target cell; performing, based on receiving the indication of the handover configuration, the handover according to the handover configuration. Further, a respective apparatus is disclosed, as well as a network entity and core network entity and respective methods performed by the same.

### FIELD OF DISCLOSURE

The following disclosure relates to the field of communication technology, in particular communication networks, in particular wireless communication networks. The disclosure may for example relate to an apparatus and a network entity that can be used for distributed unit controlled mobility.

### BACKGROUND

In 5G systems and modern communication technologies in general, a cell-specific vertical protocol stack structure with layer 3 (RRC), layer 2 (PDCP, RLC, MAC) and layer 1 is utilized. The RRC layer provides all information on parameters for configuring the other layers (layer 1, layer 2). At the UE side, a twin (identical) version of the RRC layer is created from a RRC message that the UE received from the network entity. Identical protocol stacks at the network side and the UE side enable perfect recovery of the IP packets. So, when the UE moves to another cell, RRC layer initiates the reconfiguration of the different (sub) layers in the whole protocol stack at the network side (e.g. an RRC entity migrates to the new cell). Corresponding configurations may be sent to UE and UE has to decode each one of the configurations for all layers in order to perform a handover.

### SUMMARY OF SOME EXAMPLE EMBODIMENTS

Example aspects and embodiments may enable using a protocol stack architecture that defines a cell at the medium access control (MAC) layer rather than the RRC layer, which may enable a cell-free architecture for PDCP and RLC layers. This may enhance deployment in cloud native environments in which a central unit is located in the cloud, while a distributed unit (DU) lies at the edge of the cloud. Example aspects and embodiments may enable to hide mobility from higher layer (RRC). Example aspects and embodiments may allow that during an intra-DU handover (serving cell and target cell provided by the same DU), the protocol structure with respect to PDCP and RLC layers is independent of the intra-DU cell change (so the cell concept may be considered transparent to PDCP layer). Example aspects and embodiments may enable that no data radio bearer (DRB) and/or Signaling Radio Bearer (SRB) re-establishment at intra-DU cell change is needed, and no security update at intra-DU cell change may be needed. Example aspects and embodiments may enable that a security key update or reestablishment of higher layer such as PDCP and RLC layer may be triggered independently from the handover procedure. For instance, after a CU receives an update of a cell ID, CU may initiate the security key update, or reestablishment when it sees the need.

According to a first example aspect, an apparatus is disclosed comprising:
means for transmitting, to a network entity (e.g. a distributed unit of the network entity), at least one measurement report (e.g. layer 1 measurement report on a target cell), the network entity providing a serving cell and a target cell for the apparatus, wherein the serving cell and the target cell share at least a protocol configuration of a radio resource control layer (e.g. the serving cell and target cell share at least a part of the radio resource control layer and/or have a common RRC entity);
means for receiving (e.g. on layer 2), from the network entity, an indication of a handover configuration for a handover of the apparatus to the target cell;
means for performing, based on (e.g. in response to or triggered by) receiving the indication of the handover configuration, the handover according to the handover configuration.

The apparatus may for instance be or be comprised in a mobile entity (e.g., a mobile telecommunication device or a mobile phone or a user equipment (UE) or a terminal device).

According to a second example aspect, distributed unit of a network entity is disclosed comprising:
means for providing a serving cell and a target cell for an apparatus, wherein the serving cell and the target cell share at least a protocol configuration of a radio resource control layer; means for receiving, from an apparatus, at least one measurement report (e.g. a layer 1 measurement report on a target cell);
means for determining, based on (e.g. in response to) the at least one measurement report, whether the apparatus is to perform a handover to the target cell;
means for, based on determining that the apparatus is to perform the handover, transmitting, to the apparatus (e.g. on layer 2 or MAC layer) an indication of a handover configuration for a handover of the apparatus to the target cell.

According to a third example aspect, a central unit of a network entity is disclosed comprising:
means for receiving, from a distributed unit of the network entity or an apparatus, a cell indicator indicating a target cell (e.g. receiving an identifier of the target cell such as CellID), the target cell and a serving cell being provided to the apparatus by a distributed unit of the network entity,
wherein the serving cell and the target cell share at least a protocol configuration of a radio resource control layer;
means for determining to perform a cell action based on the cell indicator.

The network entity, in particular the network entity according to the second and/or third example aspect, may for instance be or be comprised in a base station, a Radio Access Network (RAN) node (such as a gNB) or part thereof. The network entity may for example comprise a central unit and at least one distributed unit. The network entity may provide cells of a cellular network for an apparatus, e.g. a serving or candidate/target cell, for instance via a distributed unit. The central unit according to the third example aspect may for instance be or be comprised in a server, server cloud, a system of servers or part thereof.

The apparatus, network entity, distributed unit or central unit according to any aspect may comprise at least one processor; and at least one memory storing instructions that, when executed by the at least one processor, cause the apparatus at least to perform the specified steps.

The means of the apparatus, network entity, distributed unit or central unit may be implemented in hardware and/or software. They may comprise for instance at least one processor for executing processor instructions for performing the required functions, at least one memory storing the instructions, or both. Alternatively, they could comprise for instance circuitry that is designed or configured to implement the required functions, for instance implemented in a chipset or a chip, like an integrated circuit. In general, the means may comprise for instance one or more processing means or processors.

The apparatus, network entity, distributed unit or central unit according to any aspect may comprise at least one processor; and at least one memory storing instructions that, when executed by the at least one processor, cause the apparatus, network entity, distributed unit or central unit at least to perform the specified steps or the steps of a method according to any example aspect. For instance, the apparatus according to the first example aspect may be an apparatus comprising at least one processor; and at least one memory storing instructions that, when executed by the at least one processor, cause the apparatus at least to perform:
transmitting, to a network entity, at least one measurement report, the network entity providing a serving cell and a target cell for the apparatus, wherein the serving cell and the target cell share at least a protocol configuration of a radio resource control layer;
receiving, from the network entity, an indication of a handover configuration for a handover of the apparatus to the target cell;
performing, based on receiving the indication of the handover configuration, the handover according to the handover configuration.

As used in this application, the term “circuitry” may refer to one or more or all of the following:
(a) hardware-only circuit implementations (such as implementations in e.g. analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

According to a fourth example aspect, a method is disclosed, the method comprising:
transmitting, to a network entity, at least one measurement report, the network entity providing a serving cell and a target cell for the apparatus, wherein the serving cell and the target cell share at least a protocol configuration of a radio resource control layer;
receiving, from the network entity, an indication of a handover configuration for a handover of the apparatus to the target cell;
performing, based on receiving the indication of the handover configuration, the handover according to the handover configuration.

The method according to the fourth example aspect may comprise the steps the apparatus of the first example aspect is configured to perform or has means for. The method may for instance be carried out, performed and/or controlled by an/the apparatus (according to the first example aspect), for instance a mobile entity (e.g., a mobile telecommunication device or a mobile phone or a user equipment or a terminal device).

According to a fifth example aspect, a method is disclosed, the method comprising:
providing a serving cell and a target cell for an apparatus, wherein the serving cell and the target cell share at least a protocol configuration of a radio resource control layer;
receiving, from an apparatus, at least one measurement report;
determining, based on the at least one measurement report, whether the apparatus is to perform a handover to the target cell;
transmitting, based on determining that the apparatus is to perform the handover, to the apparatus, an indication of a handover configuration for a handover of the apparatus to the target cell.

The method according to the fifth example aspect may comprise the steps the distributed unit of the second example aspect is configured to perform or has means for. The method may for instance be carried out, performed and/or controlled by an/the a distributed unit of a network entity (according to the second example aspect), for instance a gNB, a RAN node, a base station, or part thereof.

According to a sixth example aspect, a method is disclosed, the method comprising:
receiving, from a distributed unit of the network entity or an apparatus, a cell indicator indicating a target cell, the target cell and a serving cell being provided to the apparatus by a distributed unit of the network entity, wherein the serving cell and the target cell share at least a protocol configuration of a radio resource control layer;
determining to perform a cell action based on the cell indicator.

The method according to the sixth example aspect may comprise the steps the central unit of the third example aspect is configured to perform or has means for. The method may for instance be carried out, performed and/or controlled by an/the central unit of a network entity (according to the third example aspect), for instance a server, a system of servers, a server cloud, or part thereof.

According to a further example aspect, a system is disclosed, the comprising at least one apparatus (e.g. mobile entity or user equipment) according to the first aspect, at least one distributed unit of a network entity according to the second aspect (e.g. providing a serving cell for the apparatus), and a central unit according to the third aspect. The system may carry out, perform and/or be configured to perform the method of any, some, or all of the fourth, fifth, or sixth example aspect.

According to a further example aspect, a computer program product is disclosed, the computer program product when executed by a processor of an apparatus causing said apparatus to perform a method according to any example aspect, e.g. at least one of the fourth, fifth, or sixth example aspect.

According to a further example aspect, an apparatus is disclosed, configured to carry out, perform and/or control or comprising respective means for performing and/or controlling the method according to the first example aspect. According to a further example aspect, an apparatus is disclosed comprising at least one processor; and at least one memory storing instructions that, when executed by the at least one processor, cause the apparatus at least to perform the method according to the first example aspect.

According to a further example aspect, a network entity or distributed unit of a network entity is disclosed, configured to carry out, perform and/or control or comprising respective means for performing and/or controlling the method according to the second example aspect. According to a further example aspect, a network entity or distributed unit of a network entity is disclosed comprising at least one processor; and at least one memory storing instructions that, when executed by the at least one processor, cause the network entity or the distributed unit of the network entity at least to perform the method according to the second example aspect.

According to a further example aspect, a network entity or a central unit of a network entity is disclosed, configured to carry out, perform and/or control or comprising respective means for performing and/or controlling the method according to the third example aspect. According to a further example aspect, a network entity or a central unit of a network entity is disclosed comprising at least one processor; and at least one memory storing instructions that, when executed by the at least one processor, cause the network entity or the central unit of a network entity at least to perform the method according to the third example aspect.

The disclosed apparatus, network entity, distributed unit or central unit according to any aspect may comprise only the disclosed components, for instance means, processor, memory, or may further comprise one or more additional components.

According to a further example aspect, a computer program is disclosed, the computer program when executed by a processor causing an apparatus, for instance a server, to perform and/or control the actions of the method according to any example aspect, e.g. at least one of the fourth, fifth, or sixth example aspect.

According to a further example aspect, a computer readable storage medium (e.g. tangible and/or non-transitory) is disclosed, the computer readable storage medium comprising at least one of the disclosed computer program products or computer programs.

Any disclosure herein relating to any example aspect is to be understood to be equally disclosed with respect to any subject-matter according to the respective example aspect, e.g. relating to an apparatus, a method, a computer program, and a computer-readable medium. Thus, for instance, the disclosure of a method step shall also be considered as a disclosure of means for performing and/or causing to perform the respective method step. Likewise, the disclosure of means for performing and/or causing to perform a method step shall also be considered as a disclosure of the method step itself. The same holds for any passage describing at least one processor; and at least one memory including instructions; the at least one memory and the instructions configured to, with the at least one processor, cause an apparatus, network device, or core network device at least to perform a step.

In the following, example features and example embodiments of all aspects will be described in further detail.

A network entity may be split into a Distributed Unit (DU) and a Central Unit (CU). A CU may be understood as a logical entity that includes network node functions, e.g. gNB functions, like transfer of user data, mobility control, radio access network sharing, positioning, session management etc., e.g. except those functions allocated exclusively to the DU. A DU may be understood as a logical entity including a subset of gNB functions. Its operation may be controlled by the CU. A gNB may consist of a gNB-CU and multiple gNB-DUs, which each may provide multiple cells.

A cell sharing a layer (e.g. a packet data convergence protocol (PDCP) layer or a radio link control (RLC) layer) or a configuration of a layer with another cell may be understood as the cell (e.g. a serving cell) and the other cell (e.g. a candidate or target cell) having at least one common configuration for that layer (e.g. the configuration is independent of the cell).

For instance, a cell sharing a (at least one) protocol configuration of a radio resource control layer with another cell may be understood as the cell (e.g. a serving cell) and the other cell (e.g. a candidate or target cell) having at least one common RRC entity. So, the serving cell and the target cell sharing at least a protocol configuration of a radio resource control layer may be or comprise the serving cell and the target cell having at least one common RRC entity. For instance, the radio resource control layer for the serving cell and target cell may be based on the same protocol configuration. For instance, the serving and target cell have a shared protocol stack e.g. up to the radio resource control layer. This may allow for the shared layers to be not cell-specific or transparent for the concept of cell. For instance, the cell may be (e.g. only) defined or managed at layer 2, e.g. a medium access control layer so that e.g. only layer 2 and layer 1 may need to be re-configured after a handover to the other cell. For example, re-configuration may be performed using a handover configuration or handover parameters comprised in a handover configuration. Handover may be referred to as a cell switch. A handover configuration may be a delta configuration. In delta configuration, difference or delta between the current configuration and a new configuration is signaled instead of signaling the whole new configuration. For example, delta configuration may be used to update UE's configuration with new parameters by signaling only the parameters that have changed.

The serving and the target cell may e.g. share a full layer, e.g. by using a common configuration for all functionalities of the layer, or the serving and target cell may only share a subset of the functions of the layer. For instance, a, e.g. shared, protocol configuration may only comprise (radio resource control) parameters not related to mobility, that may be used to configure the functionalities of the layer except the mobility related functionalities. For example, while a radio resource control layer (e.g. with the full RRC functionality) may be shared between a serving and a target cell, a distributed unit may be an entity configured with a mobility radio resource control layer, i.e. an additional radio resource control layer specifically configured to enable carrying out (substantially) all necessary actions for apparatus mobility, e.g. without the radio resource control layer of the central unit being involved. Such a concept of splitting an RRC layer into a shared RRC layer, which may be denoted as RRC-H, and a mobility radio resource control layer, which may be denoted as RRC-L, may be called dual RRC. RRC-H may or may not be aware of the concept of cells, e.g. of the serving and target cell. In case RRC-H is aware of the cells, intra-DU handovers may be determined by a DU, wherein the DU transmits a cell indicator indicating the target cell, for instance indicating that the target cell is associated with an apparatus, by RRC-L to RRC-H used by the CU. In case RRC-H is not aware of the cells, DU may manage all functions related to apparatus mobility, so e.g. no interface between RRC-H and RRC-L may be needed. So, the mobility radio resource control layer RRC-L may be specific for a cell, whereas the radio resource control layer RRC-H may be shared between different cells (e.g. a cell sharing a (at least one) protocol configuration of a radio resource control layer with another cell). RRC-L may be understood as a distributed part of the radio resource control layer or as an additional (separate) radio resource control layer for handling mobility.

Re-establishing a layer may be understood as re-configuring said layer, e.g. based on configuration parameters for the layer comprised in a re-establishment indication.

A network entity may, for instance, identify a set of candidate (target) cells for an apparatus based on received measurement reports, wherein the candidate (target) cells may be provided by the first network entity or a second network entity, and configure the network entity providing the candidate (target) cells e.g. for conditional handover execution by an apparatus (e.g. UE).

An apparatus may perform a handover to a target cell (e.g. of a set of candidate target cells), e.g. based on receiving an indication of a handover configuration. The indication of a handover configuration may be referred to as a handover trigger. In a handover, the apparatus's serving cell is changed from the (original) serving cell to the target cell. A handover may e.g. be conditional handover (CHO) to a target cell (e.g. of a set of candidate target cells) or a conditional primary serving cell (PCell) change (CPAC) to a target PCell of a set of candidate target cells. In CHO or CPAC an apparatus may be prepared with a set of potential target cells in advance by the current serving network entity, i.e. the network entity providing a cell via which the apparatus is connected to the network. The apparatus may receive and save a set of handover commands for each of the candidate target cells or cell groups. The apparatus may determine whether a predefined condition is met (such as a measured signal quality exceeds a predefined quality threshold), and on determining that the condition is met perform a handover (CHO or CPAC).

A configuration group may indicate a group of cells e.g. comprising the serving cell and the target cell, that share at least the protocol configuration of the radio resource control layer, e.g. at least a part of the radio resource control layer for the cells of the group of cells is based on the same protocol configuration. A configuration index may indicate a configuration of a specific cell (e.g. the target cell) within the group of cells. The configuration index may be relative to the group of cells, i.e. it may identify a specific cell in combination with the indication of the configuration group.

The indication of the handover may be or may be comprised in a medium access control control element (MAC CE) or a radio resource control (RRC) message. The indication may be a handover trigger e.g. for triggering a handover according to the handover configuration. For instance, the indication may be or may be comprised in MAC-CE cell change trigger with or without CHO condition, an RRC message or command “RRCReconfigurationWithSync”, or an RRC message or command “RRCReconfigurationWithoutRACH” with or without CHO condition. Performing the handover may be based on receiving the indication of the handover configuration. For example, the handover is performed in response to or triggered by receiving the indicator of the handover.

The serving cell and the target cell being managed at layer 2 (e.g. MAC layer) may be understood as the concept of cell(s) being defined at layer 2 (e.g. instead of layer 3), so that (substantially) all cell related actions, such as a handover to another cell, are managed or performed at layer 2, while e.g. layer 3 is not involved in such cell-related actions.

For example, completion of a handover and/or a new cell identity may be indicated from RRC-L to RRC-H based on a condition, e.g. report condition. A report condition may be, for instance, that the target cell is part of a group of cells, which may have been configured previously. The group of cells may, for instance, be or comprise the cells that are at the border of the area covered by the cells of the distributed unit currently providing a serving cell for the apparatus.

When a UE is located in a group of cells at the border of the area covered by the cells of the DU, a central unit (CU) may become aware, e.g. by receiving a corresponding indication from the DU, that it needs to configure to the UE mobility measurements, such as layer 3 measurements, that will be handled by the CU. Or, the group of cells may, for instance, be or comprise a mobility tracking area (which may e.g. be cells covering a route along a high-way and/or cells covering a pedestrian area) and/or cells with same or different frequency layers. Such groups of cells may, for instance, enhance configuration (e.g. via higher layers) of an apparatus as needed.

The report condition may comprise or be a cell-change count threshold (e.g. the number of handover during a certain time interval or the frequency of handovers of the apparatus to a target cell), which may allow e.g. higher layers (e.g. a central unit) to update security based on the frequency of handover as opposed to based on time. Updating security may comprise e.g. transmitting a key indication of a security key, so that the apparatus may generate a new security key based on the key indication. The report condition may comprise or be a traversal condition, e.g. a condition being fulfilled when certain cells or a group of cells have been traversed (e.g. in that handover to the certain cells or to a cell of the group of cells was performed) by the apparatus. Via a report condition a security update (in the PDCP layer) may be triggered in the MAC layer.

The report condition (e.g. group of cells, or cell switch count) may be configured to the layer in the network handling cell switches, which may be a distributed unit and/or media access control layer or mobility radio resource control layer (e.g. RRC-L). Additionally or alternatively, the report condition may be configured or pre-configured to the apparatus (e.g. UE).

A cell indicator indicating the target cell may be an identifier of the target cell such as CellID.

Determining whether the apparatus is located at a border of an area covered by cells provided by the distributed unit may be performed by a network entity (e.g. a DU of the network entity) identifying the serving and/or target cell as being a cell on the edge of the area covered by the cells provided by the network entity. The cells at the border may e.g. be comprised in a dedicated group of cells, which the network entity is aware of.

A security key may be a (master) key for establishing a security context with a network entity via the target cell or a cell group provided by the network entity including the target cell. For example, the security key may be used for establishing the security context with the network entity via any one of the cells of the cell group.

A security key (e.g. KgNB) may be generated by a network entity or an apparatus, wherein the same security key may be derived by both an apparatus and a network entity when the generation is based on the same method using the same parameters. For example, the security key may be generated based at least on one of the following: a physical cell identifier of a cell (e.g. CellID), a frequency of the cell, an unused next hop-chaining-count value of the network entity, a security key for establishing a security context with the network entity via the (former) serving cell. A security key may be generated based on non-access stratum (NAS) level keys.

A key indication may comprise information on which parameters and/or method to use or the parameters and method may be pre-defined by the network, so that e.g. an apparatus receiving a key indication may generate the security key based on the key indication.

According to an example of the first, second, fourth, or fifth example aspect, the indication of the handover indicates at least one of a configuration group or a configuration index.

According to an example of the first, second, fourth, or fifth example aspect, the handover configuration comprises handover parameters for layers not shared between the serving cell and the target cell and wherein performing the handover according to the handover configuration comprises reconfiguring the layers (or parts of layers) not shared between the serving cell and the target cell based on the handover parameters (and e.g. not reconfiguring the layers shared between the serving and the target cell).

According to an example of the first, second, fourth, or fifth example aspect, the handover configuration comprises handover parameters only for layer 2 (e.g. MAC layer) and layer 1 (e.g PHY layer) (but e.g. does not comprise handover parameters for layer 3), and wherein performing the handover according to the handover configuration comprises reconfiguring layer 1 and layer 2 based on the handover configuration.

According to an example of the first, second, fourth, or fifth example aspect, the serving cell and the target cell(s) are managed at layer 2. For instance, a distributed unit may provide the serving cell and a set of candidate (target) cells sharing a common RRC entity or a protocol configuration of a radio resource control layer, wherein the target cell is a cell of the set of candidate (target) cells, to which a handover is (to be) performed. Then, for instance, (substantially) all actions related to the handover are performed or managed at layer 2.

According to an example of the first, second, fourth, or fifth example aspect, the serving cell and the target cell further share at least one of a packet data convergence protocol (PDCP) layer or a radio link control (RLC) layer (e.g. the Packet Data Convergence Protocol or a Radio Link Control layer may be based on the same configuration in both the serving and the target cell, i.e no re-establishment or re-configuration of the respective layer would be needed after a handover). For instance, the packet data convergence protocol layer or a radio link control layer may be configured according to the same configuration/configuration parameters for the serving and target cell (or set of candidate cells) in the apparatus and in the network entity. The sharing of the respective layer may pertain to only some set of functions of that layer, so that only a part of the layer is shared (i.e. the remaining part would be an unshared PDCP or RLC layer).

According to an example of the first example aspect, the apparatus further comprising: means for, based on completing the handover (e.g. after applying the handover configuration), transmitting, to the network entity, a completion indicator (e.g. ACK) indicating completion of the handover.

According to an example of the first example aspect, the apparatus further comprising: means for receiving, from the network entity, after performing the handover, a key indication indicating a security key;
means for generating the security key based on the key indication.

According to an example of the first example aspect, the apparatus further comprising:
means for receiving, from the network entity, after performing the handover, a re-establishment indication comprising an indication of configuration parameters for a layer (e.g. PDCP layer); means for re-establishing the layer based on the re-establishment indication.

According to an example of the first example aspect, the apparatus further comprising:
means for receiving, from the network entity, after performing the handover, a handover configuration for a layer 3 handover (e.g. comprised in a trigger for the layer 3 handover) to a cell provided by another network entity or a layer 3 handover to a cell provided by a distributed unit (of the network entity) not providing the serving cell;
means for performing, based on receiving the handover configuration for the layer 3 handover, the layer 3 handover.

According to an example of the first example aspect, the apparatus further comprising: means for determining whether the handover was completed;
means for, based on determining that the handover was completed, transmitting, to a central unit of the network entity, a cell indicator indicating the target cell (e.g. transmitting an identifier of the target cell such as CellID).

According to an example of the first example aspect, the apparatus further comprising:
means for receiving, from the network entity, a report condition, wherein the transmitting the cell indicator is performed based on determining that the report condition is fulfilled (the report condition e.g. being that the target cell is or is not part of a pre-configured set of cells).

According to an example of the second or fifth example aspect, the determining whether the apparatus is to perform the handover is performed in layer 2, in particular a medium access control layer.

According to an example of the second or fifth example aspect, the determining whether the apparatus is to perform the handover, is performed in a mobility radio resource control layer (e.g. RRC-L), wherein the mobility radio resource control layer is a radio resource control layer utilized by the distributed unit.

According to an example of the second example aspect, the distributed unit further comprising:
means for determining whether the handover was completed;
means for, based on determining that the handover was completed, transmitting, to a central unit of the network entity, a cell indicator indicating the target cell (e.g. transmitting an identifier of the target cell).

According to an example of the second or fifth example aspect, the transmitting the cell indicator is performed based on determining that a report condition is fulfilled (the report condition e.g. being that the target cell is not part of a pre-configured set of cells).

According to an example of the second example aspect, the distributed unit further comprising:
means for, based on transmitting the indication of the handover, receiving, from the apparatus, a completion indicator indicating completion of the handover, wherein the transmitting the cell indicator is based on the receiving the completion indicator.

According to an example of the second example aspect, the distributed unit further comprising:
means for determining whether the apparatus is located at a border of an area covered by cells provided by the distributed unit;
means for, based on determining that the apparatus is located at the border, transmitting, to a central unit of the network entity, a border indication (e.g. e.g. “DU border: true”) indicating that the apparatus is located at the border of an area covered by cells provided by the distributed unit.

According to an example of the third example aspect, the cell action comprising a security key update, the central unit further comprising:
means for transmitting, to the apparatus, based on determining to perform the security key update, a key indication indicating a security key (e.g. for the apparatus to generate a security key).

According to an example of the third example aspect, the cell action comprising a layer re-establishment of a layer, the central unit further comprising:
means for transmitting, to the apparatus, based on determining to perform the layer re-establishment, a re-establishment indication comprising an indication of configuration parameters for the layer;
means for re-establishing the layer based on the configuration parameters for the layer (e.g. by applying the configuration parameters).

According to an example of the third example aspect, the cell action comprising determining a handover configuration for a layer 3 handover to a cell provided by another network entity or a cell provided by another distributed unit of the network entity, the central unit further comprising:
means for determining, based on determining to perform the cell action based on the cell indicator, the handover configuration for the layer 3 handover;
means for transmitting, to the apparatus, the handover configuration for the layer 3 handover.

According to an example of the third example aspect, the determining the handover configuration for the layer 3 handover is based on the apparatus being located at a border of an area covered by the cells provided by the distributed unit.

According to an example of the third example aspect, the central unit further comprising:
means for receiving, from the distributed unit, a border indication indicating that the apparatus is located at the border of an area covered by cells provided by the distributed unit; wherein the determining the handover configuration for the layer 3 handover is based on the border indication.

According to an example of the third example aspect, the cell action comprising determining a report condition (e.g. for the apparatus to transmit a cell indicator based on determining that the report condition is fulfilled), the central unit further comprising:
means for determining, based on determining to perform the cell action based on the cell indicator, the report condition;
means for transmitting, to the apparatus or the distributed unit, the report condition.

According to an example of the third example aspect, the central unit further comprising:
means for maintaining a configuration of least one of a packet data convergence protocol layer or a radio link control layer.

According to an example of the third or sixth example aspect, the serving cell and the target cell are managed at layer 2.

According to an example of the fourth example aspect, the method further comprising:
transmitting, based on completing the handover, to the network entity, a completion indicator indicating completion of the handover.

According to an example of the fourth example aspect, the method further comprising:
receiving, from the network entity, after performing the handover, a key indication indicating a security key;

According to an example of the fourth example aspect, the method further comprising:
receiving, from the network entity, after performing the handover, a re-establishment indication comprising an indication of configuration parameters for a layer;
re-establishing the layer based on the re-establishment indication.

According to an example of the fourth example aspect, the method further comprising:
receiving, from the network entity, after performing the handover, a handover configuration for a layer 3 handover to a cell provided by another network entity or a layer 3 handover to a cell provided by a distributed unit not providing the serving cell;
performing, based on receiving the handover configuration for the layer 3 handover, the layer 3 handover.

According to an example of the fourth example aspect, the method further comprising:
determining whether the handover was completed;
transmitting, based on determining that the handover was completed, to a central unit of the network entity, a cell indicator indicating the target cell.

According to an example of the fourth example aspect, the method further comprising:
receiving, from the network entity, a report condition, wherein the transmitting the cell indicator is performed based on determining that the report condition is fulfilled.

According to an example of the fifth example aspect, the method further comprising:
determining whether the handover was completed;
transmitting, based on determining that the handover was completed, to a central unit of the network entity, a cell indicator indicating the target cell.

According to an example of the fifth example aspect, the method further comprising:
receiving, based on transmitting the indication of the handover, from the apparatus, a completion indicator indicating completion of the handover, wherein the transmitting the cell indicator is based on the receiving the completion indicator.

According to an example of the fifth example aspect, the method further comprising:
determining whether the apparatus is located at a border of an area covered by cells provided by the distributed unit;
transmitting, based on determining that the apparatus is located at the border, to a central unit of the network entity, a border indication indicating that the apparatus is located at the border of an area covered by cells provided by the distributed unit.

According to an example of the sixth example aspect, the cell action comprises a security key update, the method further comprising:
transmitting, to the apparatus, based on determining to perform the security key update, a key indication indicating a security key.

According to an example of the sixth example aspect, the cell action comprises a layer re-establishment of a layer, the method further comprising:
transmitting, to the apparatus, based on determining to perform the layer re-establishment, a re-establishment indication comprising an indication of configuration parameters for the layer;
re-establishing the layer based on the configuration parameters for the layer.

According to an example of the sixth example aspect, the cell action comprises determining a handover configuration for a layer 3 handover to a cell provided by another network entity or a cell provided by another distributed unit of the network entity, the method further comprising:
determining, based on determining to perform the cell action based on the cell indicator, the handover configuration for the layer 3 handover;
transmitting, to the apparatus, the handover configuration for the layer 3 handover.

According to an example of the sixth example aspect, the method further comprising:
receiving, from the distributed unit, a border indication indicating that the apparatus is located at the border of an area covered by cells provided by the distributed unit; wherein the determining the handover configuration for the layer 3 handover is based on the border indication.

According to an example of the sixth example aspect, the cell action comprises determining a report condition, the method further comprising:
determining, based on determining to perform the cell action based on the cell indicator, the report condition;
transmitting, to the apparatus or the distributed unit, the report condition.

According to an example of the sixth example aspect, the method further comprising:
maintaining a configuration of least one of a packet data convergence protocol layer or a radio link control layer.

The features and example embodiments described above may equally pertain to the different aspects, for instance a means for performing a method step may equally disclose said method step and vice versa, e.g. a method step described relating to the fourth example aspect may equally disclose a respective means for performing this method step by an apparatus according to the first example aspect and vice versa; a method step described relating to the fifth example aspect may equally disclose a respective means for performing this method step by a network entity according to the second example aspect and vice versa; a method step described relating to the sixth example aspect may equally disclose a respective means for performing this method step by a core network entity according to the third example aspect and vice versa.

It is to be understood that the presentation in this section is merely by way of examples and non-limiting.

Other features will become apparent from the following detailed description considered in conjunction with the accompanying drawings. It is to be understood, however, that the drawings are designed solely for purposes of illustration and not as a definition of the limits, for which reference should be made to the appended claims. It should be further understood that the drawings are not drawn to scale and that they are merely intended to conceptually illustrate the structures and procedures described herein.

### BRIEF DESCRIPTION OF THE DRAWINGS

The drawings show:

FIG. 1 is a schematic drawing showing an example system;

FIG. 2 is a flowchart showing an example embodiment of a method according to the fourth example aspect;

FIG. 3 is a flowchart showing an example of a method according to the fifth example aspect;

FIG. 4 is a flowchart showing an example of a method according to the sixth example aspect;

FIG. 5 is an example of a protocol stack architecture;

FIG. 6 is an example of a protocol stack architecture;

FIG. 7 is an example message sequence chart showing an example of a method according to the fourth, fifth, and sixth example aspect;

FIG. 8 is an example message sequence chart showing an example of a method according to the fourth, fifth, and sixth example aspect;

FIG. 9 is an example message sequence chart showing an example of a method according to the fourth, fifth, and sixth example aspect;

FIG. 10 is an example message sequence chart showing an example of a method according to the fourth, fifth, and sixth example aspect;

FIG. 11 is an example message sequence chart showing an example of a method according to the fourth, fifth, and sixth example aspect;

FIG. 12 is an example message sequence chart showing an example of a method according to the fourth, fifth, and sixth example aspect;

FIG. 13 is a schematic block diagram of an example of an apparatus according to the first aspect and/or an example embodiment of network note according to the second and/or third example aspect;

FIG. 14 is a schematic illustration of examples of (tangible and/or non-transitory) computer-readable storage media.

### DETAILED DESCRIPTION OF SOME EXAMPLES

The following description serves to deepen the understanding and shall be understood to complement and be read together with the description as provided in the above summary section of this specification. Some aspects may have a different terminology than e.g. provided in the description above. For instance a handover may be described as a cell change or cell switch. The skilled person will nevertheless understand that those terms refer to the same subject-matter, e.g. by being more specific.

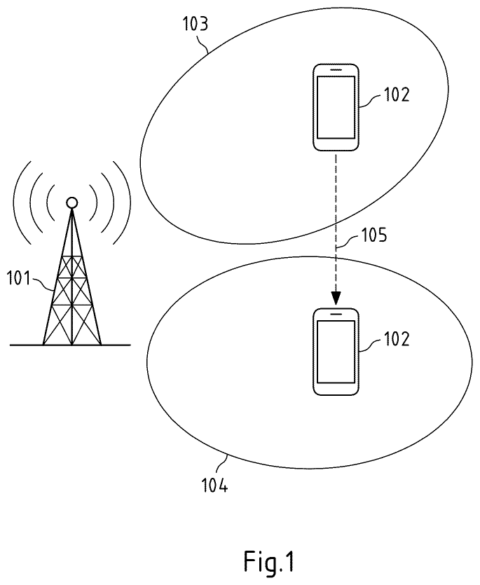

FIG. 1 shows a schematic drawing of an example system, e.g. a system according to an example aspect disclosed above. A network entity (or distributed unit of the network entity) 101 provides a (current) serving cell 103 and a (candidate) target cell 104 to apparatus 102. When the apparatus moves 105 and transmits measurements reports e.g. on serving cell 103 and target cell 104, the network entity or distributed unit 101 may send an indication of a handover configuration for a handover of the apparatus 102 to the target cell 104 (e.g. comprised in a handover trigger, such as a MAC CE trigger). Subsequently, the apparatus may perform a handover to the target cell 104. The apparatus 102 may be a user equipment, UE.

Example embodiments described may be implemented in a radio system. Some examples of a suitable communication networks include a 5G network and/or a 6G network. The 3GPP solution to 5G is referred to as New Radio (NR). 6G is envisaged to be a further development of 5G. NR has been envisaged to use multiple-input-multiple-output (MIMO) multi-antenna transmission techniques, more base stations or nodes than the current network deployments of LTE (a so-called small cell concept), including macro sites operating in co-operation with smaller local area access nodes and perhaps also employing a variety of radio technologies for better coverage and enhanced data rates. 5G will likely be comprised of more than one radio access technology/radio access network (RAT/RAN), each optimized for certain use cases and/or spectrum. 5G mobile communications may have a wider range of use cases and related applications including video streaming, augmented reality, different ways of data sharing and various forms of machine type applications, including vehicular safety, different sensors and real-time control. 5G is expected to have multiple radio interfaces, namely below 6 GHz, cmWave and mmWave, and being integrable with existing legacy radio access technologies, such as the LTE.

The current architecture in LTE networks is distributed in the radio and centralized in the core network. The low latency applications and services in 5G may require bringing the content close to the radio which leads to local break out and multi-access edge computing (MEC). 5G enables analytics and knowledge generation to occur at the source of the data. This approach may require leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications). Edge cloud may be brought into RAN by utilizing network function virtualization (NVF) and software defined networking (SDN). Using edge cloud may mean access node operations to be carried out, at least partly, in a server, host or node operationally coupled to a remote radio head or base station comprising radio parts. Network slicing allows multiple virtual networks to be created on top of a common shared physical infrastructure. The virtual networks are then customised to meet the specific needs of applications, services, devices, customers or operators.

In radio communications, node operations may be carried out, at least partly, in a central/centralized unit, CU, (e.g. server, host or node) operationally coupled to a distributed unit, DU, (e.g. a radio head/node). It is also possible that node operations will be distributed among a plurality of servers, nodes or hosts. It should also be understood that the distribution of work between core network operations and base station operations may vary depending on implementation. Thus, 5G networks architecture may be based on a so-called CU-DU split. One gNB-CU controls several gNB-DUs. The term ‘gNB’ may correspond in 5G to the eNB in LTE. The gNBs (one or more) may communicate with one or more UEs. The gNB-CU (central node) may control a plurality of spatially separated gNB-DUs, acting at least as transmit/receive (Tx/Rx) nodes. In some embodiments, however, the gNB-DUs (also called DU) may comprise e.g. a radio link control (RLC), medium access control (MAC) layer and a physical (PHY) layer, whereas the gNB-CU (also called a CU) may comprise the layers above RLC layer, such as a packet data convergence protocol (PDCP) layer, a radio resource control (RRC) and an internet protocol (IP) layers.

The plurality of network entities 101, e.g. gNBs (access points/nodes), each comprising the CU and one or more DUs, may be connected to each other via the Xn interface over which the gNBs may negotiate. The gNBs may also be connected over next generation (NG) interfaces to a 5G core network (5GC), which may be a 5G equivalent for the core network of LTE. Such 5G CU-DU split architecture may be implemented using cloud/server so that the CU having higher layers locates in the cloud and the DU is closer to or comprises actual radio and antenna unit.

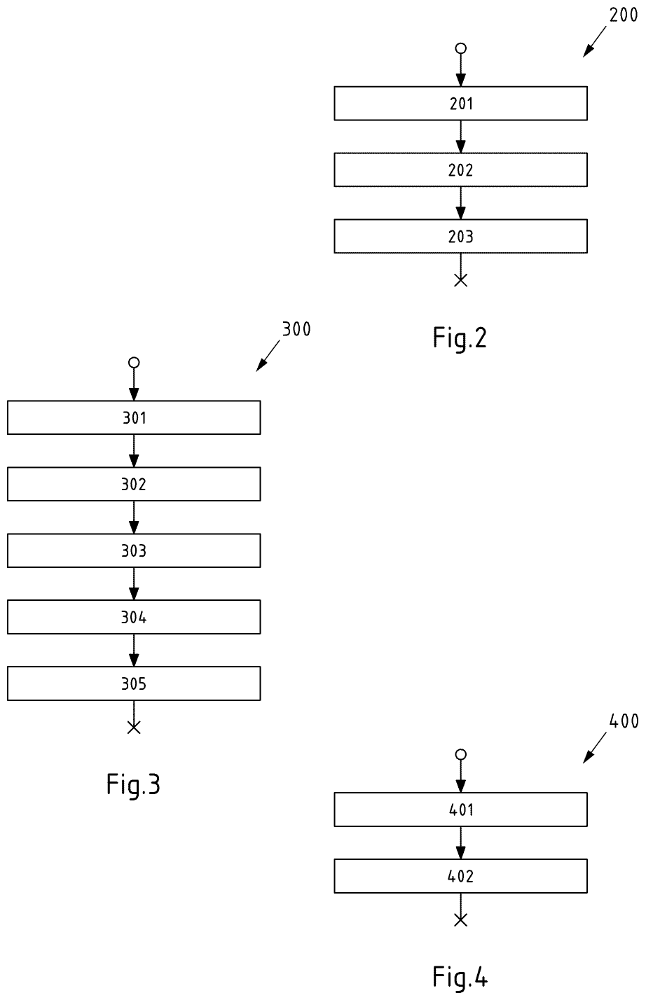

FIG. 2 is a flowchart showing an example of a method 200 according to the fourth example aspect. The example method may be performed or carried out by an apparatus, e.g. a user device or user equipment, and comprises:
transmitting 201, to a network entity, at least one measurement report, the network entity providing a serving cell and a target cell for the apparatus, wherein the serving cell and the target cell share at least a protocol configuration of a radio resource control layer;
receiving 202, from the network entity an indication of a handover configuration for a handover of the apparatus to the target cell;
performing 203, based on receiving the indication of the handover configuration, the handover according to the handover configuration.

FIG. 3 is a flowchart showing an example of a method 300 according to the fifth example aspect. The example method may be performed or carried out by a distributed unit of a network entity, e.g. a RAN node or gNB, and comprises:
providing 301 a serving cell and a target cell for an apparatus, wherein the serving cell and the target cell share at least a protocol configuration of a radio resource control layer; receiving 302, from an apparatus, at least one measurement report;
determining 303, based on the at least one measurement report, whether the apparatus is to perform a handover to the target cell;
transmitting 304, based on determining that the apparatus is to perform the handover, to the apparatus, an indication of a handover configuration for a handover of the apparatus to the target cell; and
transmitting 305 to a central unit of the network entity, a cell indicator indicating the target cell.

FIG. 4 is a flowchart showing an example embodiment of a method 400 according to the sixth example aspect. The example method may be performed or carried out by a central unit of a network entity, the central unit e.g. being on a server, and comprises:
receiving 401, from a distributed unit of the network entity or an apparatus, a cell indicator indicating a target cell, the target cell and a serving cell being provided to the apparatus by a distributed unit of the network entity, wherein the serving cell and the target cell share at least a protocol configuration of a radio resource control layer;
determining 402 to perform a cell action based on the cell indicator.

For example, to enhance signaling, e.g. by a UE not having to decode configurations for all layers in order to perform handover a protocol stack architecture is disclosed (e.g. according to any aspect; the serving cell and the target cell share at least a protocol configuration of a radio resource control layer) that defines cell at MAC, which may achieve cell-free architecture for PDCP and RLC layers. This may facilitate deployment in cloud native environment in which CU lies in the cloud, while DU lies at the edge of the cloud. The concept of cell may be used for the purpose of network optimization. For example, during handover when RACH is performed, and how resource may be reused across cell. According to the disclosed architecture (e.g. according to any aspect) the concept of cell may be decoupled in the higher layers, which may simplify the handover procedure, by moving the concept of cell to the MAC (sub) layer in which the cell is defined and managed. CU-DU interaction may be minimized. For example, only DU may be reconfigured when it is needed. This may e.g. allow hiding mobility from higher layer (e.g. layer 3, RRC, PDCP, RLC). Different examples and example aspects may relate to single RRC or dual RRC. Examples and example aspects may allow for performing a handover without RRC reconfiguration. Defining cell at MAC may focus on intra-DU handover.

An example of hiding mobility from higher layer is provided in the following:

No PDCP, RLC re-establishment may be needed during handover. No DRB and SRB re-establishment during handover may be needed, which may enable LTM. With the disclosed protocol architecture, because cell may be defined and managed at MAC layer, an RRC reconfiguration command may not be needed to activate LTM. A cell switch or handover may be performed from lower layer measurement. Moreover, the re-establishment of PDCP, RLC, RRC layer may be decoupled from handover. For instance, the security key update may be decoupled. For example, the decoupling may extend to the decoupling of re-establishment of PDCP, RLC, RRC layer.

Upon receiving the new cell ID from MAC in CU, CU may decide to perform security key update, or trigger PDCP re-establishment. The disclosed architecture may allow decoupling of re-establishment of PDCP, RLC and RRC layer from the handover procedure The update of security key may e.g. not be triggered only by handover. Network may implement algorithm to determine the safety of the environment and e.g. trigger the update of security when it sees the need.

For example (according to any aspect):
1. After the handover is complete, MAC may inform CU about the new cell ID, e.g. by transmitting a cell indicator indicating the target cell to the CU.
2. Upon receiving a new cell ID in CU from MAC, e.g. by receiving, from a distributed unit of the network entity or an apparatus, a cell indicator indicating a target cell, CU may make the decision, e.g. CU may determine to perform a cell action
   a. trigger PDCP re-establishment (e.g. determining to re-establishing a (PDCP) layer)
   b. update the security key (e.g. determining to perform a security key update).
   c. configure L3 handover if the UE is at DU border (e.g. determining a handover configuration for a layer 3 handover based on the apparatus being located at a border of an area covered by the cells provided by the distributed unit)

Examples of any aspect may relate to single RRC, dual RRC, UE driven. In single RRC, the re-establishment of PDCP, RLC, and even RRC layer may be decoupled. The security key update for example may not be triggered by handover. In Dual RRC, there may also be a PDCP layer in RRC-L, hence, the decoupling may be understood as the decoupling of re-establishment of the PDCP-H in CU from PDCP-L in DU. In other words, the update of security could be at different time between CU and DU.

Examples of any aspect may relate to intra-DU handover.

A cell at MAC protocol stack architecture as disclosed above may hide the mobility from higher layer, namely RLC, PDCP and RRC layer. For example, (according to examples of any aspect) security key may not be needed to change because the PDCP entity is not changed. However, due to security reasons, the security key may be updated at least periodically. For example: If the keys are left static for an extended period of time, malicious attackers may have more time to break/crack/decode them. As disclosed, cell is defined and managed at MAC layer, subsequently allowing MAC to manage mobility. Decoupling the re-establishment of PDCP, RLC, or even RRC layer (e.g. according to examples of any aspect), may enable MAC to link periodic security updates to the frequency of cell changes, or traversal of cell groups, by informing the higher layers about the traversed cells. An interface between MAC and CU as disclosed herein may allow MAC layer to trigger a security update in the PDCP sublayer.
1. Single RRC (e.g. in a 5G framework)
   a. MAC layer at the DU may inform the RRC layer at the CU about the new cell ID. This new cell ID information may be needed at CU, because CU may need to know where the UE is for sending the paging control information at least, as well as the possibility of updating security key. In addition, core network may also require the cell ID information from CU.
2. Dual RRC (e.g. one (full function) RRC denoted as RRC-H and a split RRC at DU which may take care of mobility at MAC, denoted as RRC-L)
   a. RRC-H may be aware of the entity of the cell. Intra-DU mobility may happen at DU. RRC-L may send RRC-H an indication that new cell ID is associated with a particular UE. This example may also allow expansion into AI/ML framework. Optimization based on update from the mobility may allow prediction on the future movement.
   b. RRC-H may be not aware of the entity of cell. As a result, RRC-L may handle completely the mobility. No interface may be needed between RRC-H and RRC-L for mobility.

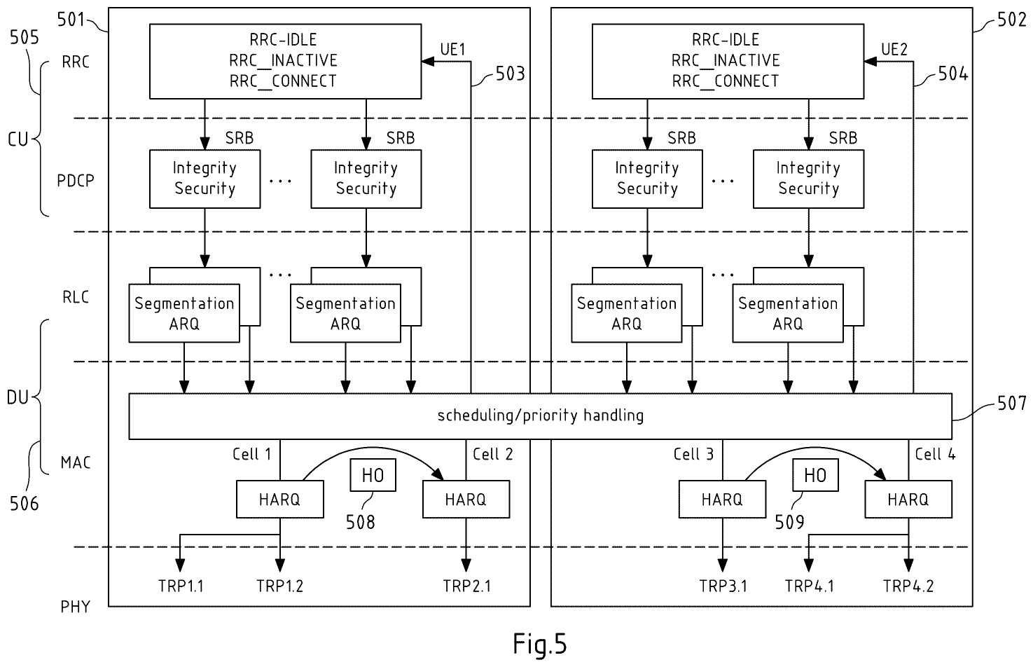

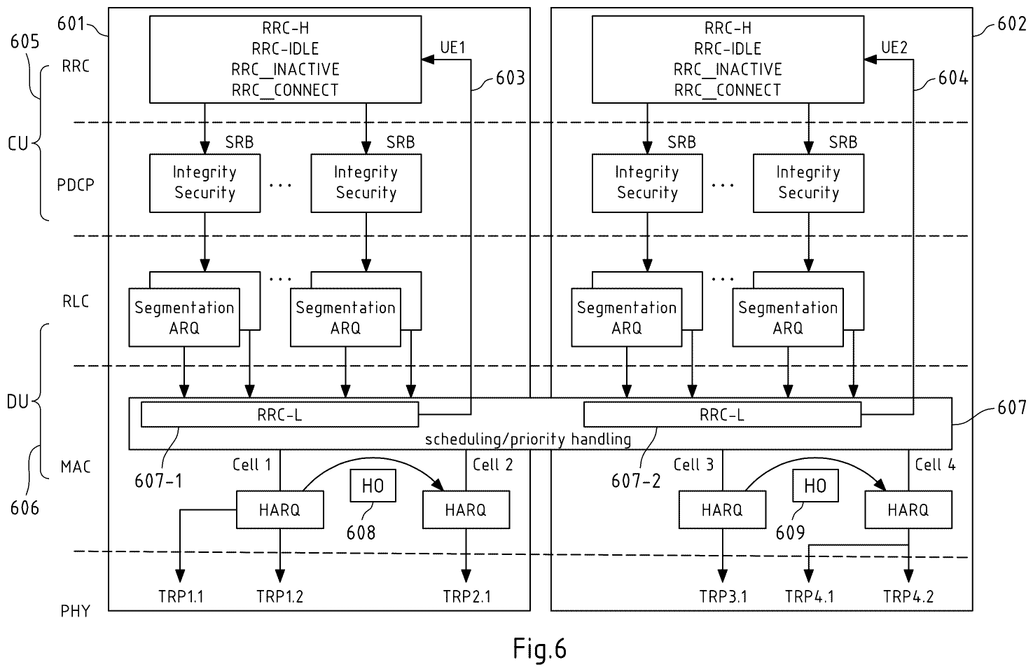

The architecture and the indication between DU and CU is illustrated in FIGS. 5 and 6.

FIG. 5 shows an example of a protocol stack architecture 501, 502 that may be used in an example according to any aspect. In the example protocol stack architecture 501 e.g. a serving cell (Cell 1) and a target cell (Cell 2) provided for an apparatus (UE1) share a protocol configuration of a radio resource control layer, e.g. they share the radio resource control layer (RRC). In this example, the serving cell and the target cell further share a packet data convergence protocol layer and a radio link control layer (e.g. the packet data convergence protocol (PDCP) layer and the radio link control (RLC) layer are based on a configuration common for both the serving and target cell). The RRC, PDCP, and RLC layer are transparent to the concept of cells. The serving cell and target cell are managed 507 in the MAC layer (e.g. scheduling, priority handling). The RRC and PDCP layer are utilized by CU 505, the RLC and MAC layer are utilized by DU 506. After apparatus UE1 performs a handover 508, DU 506 via the MAC layer 507 (or UE1) transmits 503, to CU 505, a cell indicator indicating the target cell. Likewise, after UE2 performs a handover 509 from serving cell (Cell 3) to target cell (Cell 4), DU 506 via the MAC layer 507 (or UE2) transmits 504, to CU 505, a cell indicator indicating the target cell (Cell 4).

FIG. 5 may relate to an architecture for single RRC. For each UE (UE1, UE2), one RRC connection may be created and anchored in the current serving cell that sets all parameters for PDCP, RLC, MAC and PHY in idle mode, inactive mode and in connected mode. In Idle and inactive mode, RRC message may bypass PDCP sublayer, and RLC sublayer, and arrive at the MAC sublayer. In connected mode, the RRC message may be integrated and ciphered in the PDCP sublayer and segmented in the RLC layer. When UE is moving across cells within a DU under the disclosed architecture, the change of serving cell may be activated by MAC-CE based on the measurement report DU receives. Different from an RRC reconfiguration command which may trigger the L3 HO or trigger the preparation of LTM, the trigger may be the MAC-CE which may contain the updated parameters related to MAC and PHY layer (which e.g. may enhance 6G mobility). Upon the completion of handover, which may be marked by UE sending back an acknowledgement, DU may send an indication about the new cell ID that UE is handed over to the RRC layer. RRC may then decide if it shall trigger the upper layers a PDCP re-establishment, such that a new security key may be generated. The interface between MAC and RRC may contain at least the new cell ID. Other fields may be open for configuration.

FIG. 6 shows an example of a protocol stack architecture 601, 602 that may be used in an example according to any aspect. In the example protocol stack architecture 601 e.g. a serving cell (Cell 1) and a target cell (Cell 2) provided for an apparatus (UE1) share a protocol configuration of a radio resource control layer, e.g. they share a (split) radio resource control layer (RRC-H), which may correspond to dual RRC. In this example, the distributed unit further utilizes a mobility radio resource control layer 607-1 (denoted as RRC-L) for determining whether the apparatus UE1 is to perform the handover 608. The mobility radio resource control layer 607-1 further is utilized to transmit 603, to CU 605, a cell indicator indicating the target cell (Cell 2). Further, the serving cell and the target cell share a packet data convergence protocol layer and a radio link control layer (e.g. the packet data convergence protocol (PDCP) layer and the radio link control (RLC) layer are based on a configuration common for both the serving and target cell). The RRC, PDCP, and RLC layer are transparent to the concept of cells. The serving cell and target cell are managed 607 in the MAC layer (e.g. scheduling, priority handling). The RRC and PDCP layer are utilized by CU 605, the RLC, mobility radio control layer and MAC layer are utilized by DU 606. Likewise, after UE2 performs a handover 609 from serving cell (Cell 3) to target cell (Cell 4), DU 506 via the mobility radio control layer 607-2 transmits 604, to CU 605, a cell indicator indicating the target cell (Cell 4).

FIG. 6 may relate to an architecture for dual RRC. For each UE, one RRC connection may be created and anchored in the current serving cell that sets all parameters for PDCP, RLC, MAC and PHY in idle mode, inactive mode and in connected mode. In the case of dual RRC, there may be two RRC units (e.g. RRC entities), but they may belong to the same serving cell. One may be RRC-H, situated in CU, one may be RRC-L, situated in DU. In Idle and inactive mode, RRC message from RRC-H may bypass PDCP sublayer, and RLC sublayer, and arrive at the MAC sublayer. In connected mode, the RRC message may be integrated and ciphered in the PDCP sublayer and segmented in the RLC layer. When UE is moving across cells within a DU under the disclosed architecture, the change of serving cell may be activated by RRC reconfiguration command based on the measurement report DU receives because there may be a RRC unit in DU. RRCReconfiguration command may contain the updated parameters related to MAC and PHY layer and may be managed by RRC-L (which e.g. may enhance 6G mobility). Upon the completion of handover, which may be marked by UE sending back an acknowledgement RRCreconfigurationComplete. RRC-L may send an indication about the new cell ID that UE is handed over to the RRC-H layer. RRC-H may then decide if it shall trigger the upper layers a PDCP re-establishment, such that a new security key may be generated.

As a further option in dual RRC, an interface between RRC-H and RRC-L may not exist. So, Access and Mobility Management Function (AMF) may contact RRC-H and RRC-L directly.

The following may apply for both single RRC and dual RRC: In a variant, the completion of a handover and the new cell ID from RRC-L may be indicated to the RRC-H based on a condition (e.g. report condition). The condition may be for instance that the new cell (target cell) is part of a group of cells (which has been configured earlier by higher layers). The group of cells could be for instance the cells that are at the border of the DU area, or a mobility tracking area (cells along a high-way vs cells in a pedestrian area, or groups of cells with different frequency layers), helping higher layers to configure the UE as needed. Likewise, the condition may be that the UE has switched to a cell which is not part of a group of cells which has been configured earlier by higher layers. This alternative can be advantageous if the group of cells that is preconfigured is small.

The condition may be also a cell-change count threshold, helping higher layers to update security based on the frequency of handover as opposed to based on time. The condition (group of cells, or cell switch count) may be configured to the layer in the network handling cell switches, which may be the DU or MAC layer or RRC-L. In another example, the condition is configured to the UE using RRC, and UE may notify higher layers upon the completion of handover.

The above disclosed architectures (single RRC, and dual RRC) may be applicable to all PHY layer deployment including dMIMO, CA and inter-cell beam management, ICBM etc. And the handover procedure such as CHO, DAPS, and LTM may be applied with the disclosed architecture.

Cell-less communication via dMIMO may allow for removing the sense of boundary on the PHY layer via dMIMO technology. In the cell-free concept by dMIMO, UE may be served by multiple-cell. Before the handover takes place, UE may already establish some sort of data connection with another cell other than serving cell. dMIMO may enable cell-free concept because cell may no longer be the criteria in deciding a handover.

In this following, it may be illustrated how baseline may work for the concept of cell at MAC, e.g. for LTM and CHO.

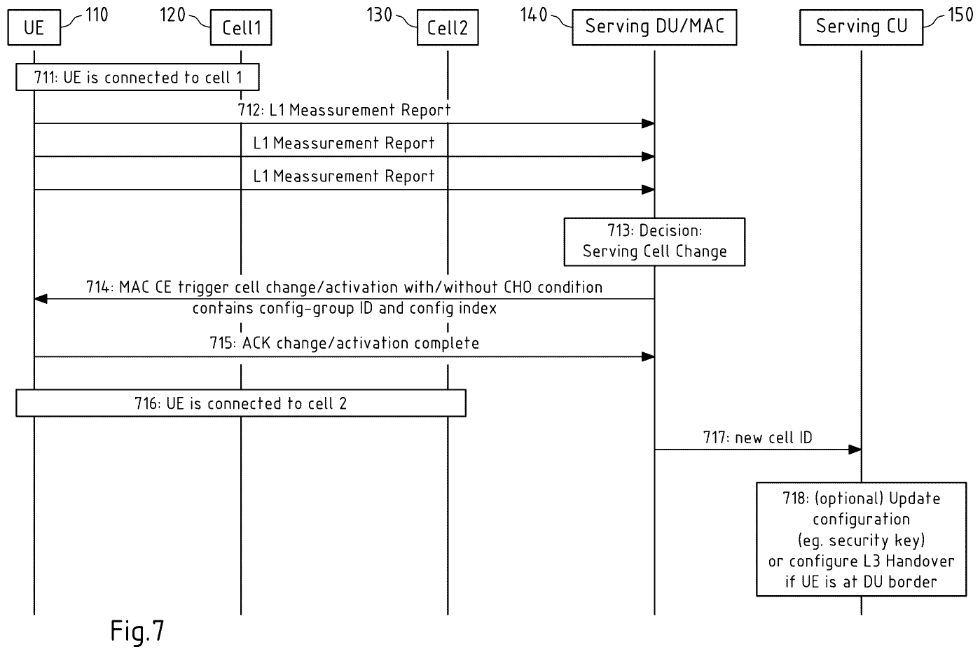

FIG. 7 shows an example message sequence chart showing an example of a method according to the fourth, fifth, and sixth example aspect. In this example, in step 712 UE 110 may transmit, to DU 140, at least one measurement report (e.g. layer 1 measurement report), DU 140 providing a serving cell 120 and a target cell 130 for UE 110, wherein the serving cell 120 and the target cell 130 share at least a protocol configuration of a radio resource control layer. In step 713, DU 140 determines, based on the at least one measurement report, whether UE 110 is to perform a handover to the target cell 130. In step 714, DU 140 transmits, based on determining that UE 110 is to perform the handover, to UE 110 an indication of a handover configuration for a handover of UE 110 to the target cell 130, the indication of the handover being comprised in a MAC CE trigger for cell change/activation with or without CHO condition. UE 110 may perform, based on receiving the indication of the handover configuration, the handover according to the handover configuration. In step 715, UE 110 transmits a completion indicator indicating completion of the handover. In step 717, DU 140 transmits, based on receiving the completion indicator, to CU 150, a cell indicator indicating the target cell 130. In step 718, CU 150 determines to perform a cell action (such as a security key update or determining a handover configuration for a layer 3 handover) based on the cell indicator.

The example of FIG. 7 may relate to baseline mobility for single RRC and may illustrate mobility within DU using the disclosed architecture. For example:

For example, step 711: UE 110 is connected to cell 1 (e.g. serving cell).

For example, step 712: Any measurements that may be sent to DU MAC sublayer may be defined as L1 measurement sent (e.g. transmit at least one measurement report). The UE beam that is used for the measurement may be indicated in the report. These measurement reports may be sent to DU MAC sublayer from UE.

For example, step 713: Upon receiving the measurement report, DU MAC sublayer may make the decision to switch cell.

For example, step 714: DU may send MAC-CE cell change trigger to UE with or without CHO condition. In this MAC-CE cell trigger, there may be RRC parameters (e.g. handover parameters) containing all information for PHY and MAC of the target cell. To simplify the interface, MAC-CE command may contain pre-configured “config-group ID” (e.g. indication of a configuration group) and config index (e.g. a configuration index) which may point to the RRC parameters containing all information for PHY and MAC of the target cell.

For example, step 715: Upon applying all the configuration at the UE side, UE may send an ACK to DU to signal the completion of activation.

For example, step 716: UE is switched to cell 2 (e.g. target cell).

For example, step 717: DU inform CU about the new cell ID.

For example, step 718: The CU may use the new cell ID for statistics for network optimizations. Upon receiving the cell ID, it may trigger security key updates. It may trigger L3 HO if UE is at DU border. According to an example, DU may detect (or determine) if UE is at DU border, and enable the indication [DU border: true](e.g. border indication) to RRC layer. A L3 HO may be event triggered if the measurement satisfied the condition, an L3 report may be sent to CU, and CU may trigger a L3 HO. Upon receiving the cell ID and [DU border: true] from DU, based on the L3 measurement report, CU may trigger L3 HO to UE. By knowing the UE is at the cell border, may help CU prioritize L3 handover over cell at MAC handover.

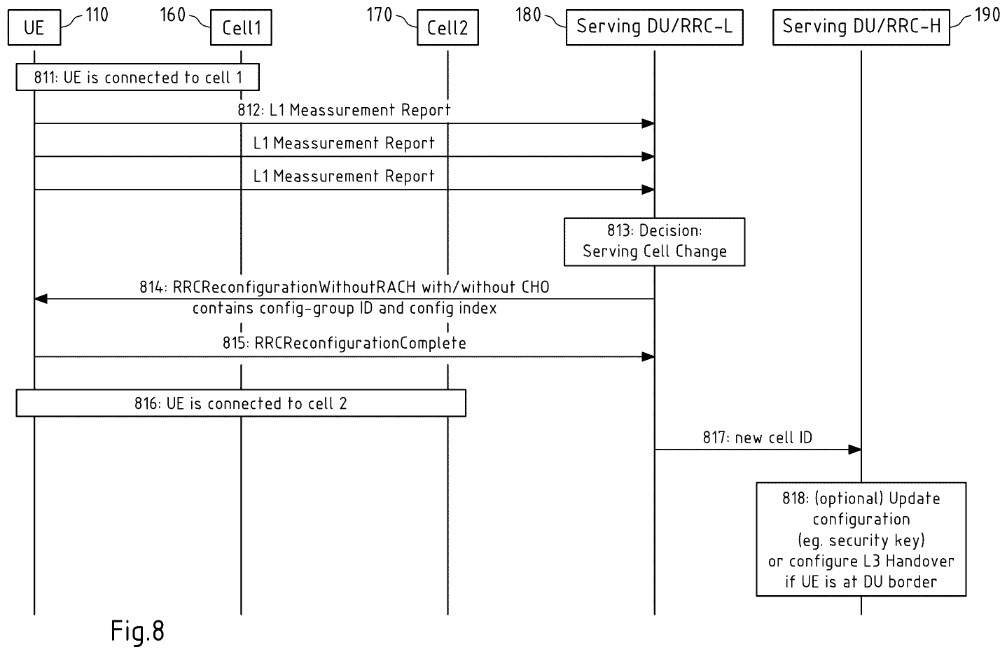

FIG. 8 shows an example message sequence chart showing an example of a method according to the fourth, fifth, and sixth example aspect. In this example, in step 812 UE 110 may transmit, to DU 180, at least one measurement report (e.g. layer 1 measurement report), DU 180 providing a serving cell 160 and a target cell 170 for UE 110, wherein the serving cell 160 and the target cell 170 share at least a protocol configuration of a radio resource control (denoted RRC-H) layer, e.g. the serving cell 160 and target cell 180 share RRC-H. DU 180 being a DU configured with a mobility radio resource control (denoted RRC-L) layer. In step 813, DU 180 determines, based on the at least one measurement report, whether UE 110 is to perform a handover to the target cell 170. In step 814, DU 180 transmits, based on determining that UE 110 is to perform the handover, to UE 110 an indication of a handover configuration for a handover of UE 110 to the target cell 170, the indication of the handover being comprised in an RRCReconfiguration message without RACH and with or without a CHO condition. UE 110 may perform, based on receiving the indication of the handover configuration, the handover according to the handover configuration. In step 815, UE 110 transmits a completion indicator indicating completion of the handover. In step 817, DU 180 transmits, based on receiving the completion indicator, to CU 190, a cell indicator indicating the target cell 170. In step 818, CU 190 determines to perform a cell action (such as a security key update or determining a handover configuration for a layer 3 handover) based on the cell indicator.

The example of FIG. 8 may relate to baseline mobility for dual RRC. For example:

For example, step 811: UE 110 is connected to cell 1 (e.g. serving cell).

For example, step 812: Any measurements that may be sent (e.g. transmit at least one measurement report) to DU RRC-L may be defined as L1 measurement. The UE beam that is used for the measurement may be indicated in the report. These measurement reports may be sent to RRC-L sublayer from UE.

For example, step 813: Upon receiving the measurement report, RRC-L sublayer may make the decision to switch cell.

For example, step 814: RRC-L may send RRC command “RRCReconfigurationWithoutRACH” to UE with or without CHO condition. In this cell switch trigger, there may be RRC parameters (e.g. handover parameters) containing all information for PHY and MAC of the target cell. To simplify the interface, RRC command “RRCReconfigurationWithoutRACH” may contain pre-configured “config-group ID” (e.g. indication of a configuration group) and config index (e.g. a configuration index) which may point to the RRC parameters containing all information for PHY and MAC of the target cell.

For example, step 815: Upon applying all the configuration at the UE side, UE sends an
RRCReconfigComplete to DU/RRC-L.

For example, step 816: UE is connected to cell 2.

For example, step 817: RRC-L informs RRC-H about the new cell ID (e.g cell indicator of target cell).

For example, step 818: The RRC-H may use the new cell ID for statistics for network optimizations. Upon receiving the new cell ID, it may trigger security key updates. It may trigger L3 HO if UE is at DU border. A L3 HO may be event triggered if the measurement satisfied the condition, an L3 report may be sent to RRC-H, and RRC-H may trigger a L3 HO. DU may detect (or determine) if UE is at DU border, and RRC-L may enable the indication [DU border: true] (e.g. border indication) to RRC-H. Upon receiving the new cell ID and [DU border: true] from RRC-L, based on the L3 measurement report, RRC-H may trigger L3 HO to UE. By knowing the UE is at the cell border, may help RRC-H prioritize L3 handover over cell at MAC handover.

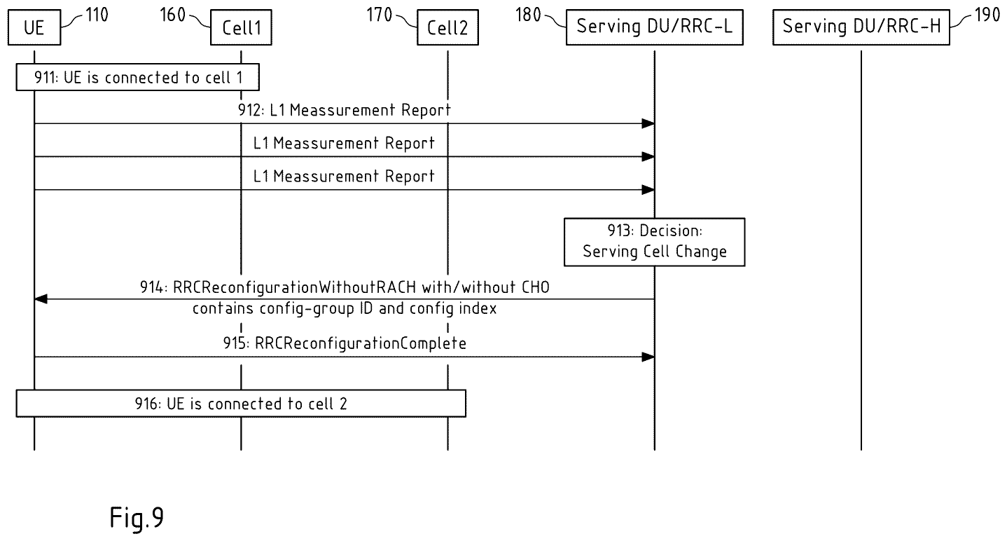

FIG. 9 shows an example message sequence chart showing an example of a method according to the fourth, fifth, and sixth example aspect. In this example, in step 912 UE 110 may transmit to DU 180, at least one measurement report (e.g. layer 1 measurement report), DU 180 providing a serving cell 160 and a target cell 170 for UE 110, wherein the serving cell 160 and the target cell 170 share at least a protocol configuration of a radio resource control (denoted RRC-H) layer. DU 180 being a DU configured with a mobility radio resource control (denoted RRC-L) layer. In step 913, DU 180 determines, based on the at least one measurement report, whether UE 110 is to perform a handover to the target cell 170. In step 914, DU 180 transmits, based on determining that UE 110 is to perform the handover, to UE 110 an indication of a handover configuration for a handover of UE 110 to the target cell 170, the indication of the handover being comprised in an RRCReconfiguration message without RACH and with or without a CHO condition. UE 110 may perform, based on receiving the indication of the handover configuration, the handover according to the handover configuration. In step 915, UE 110 transmits a completion indicator indicating completion of the handover, the completion indicator e.g. being RRCReconfiguration complete.

The example of FIG. 9 may relate to baseline mobility for dual RRC. For example:

For example, step 911: UE is at connected to cell 1.

For example, step 912: Any measurements that may be sent to DU RRC-L may be defined as L1 measurement. The UE beam that is used for the measurement may be indicated in the report. These measurement reports may be sent to RRC-L sublayer from UE.

For example, step 913: Upon receiving the measurement report, RRC-L sublayer may make the decision to switch cell (e.g. determining whether the apparatus is to perform a handover to the target cell).

For example, step 914: RRC-L may send a RRC command “RRCReconfigurationWithoutRACH” to UE with or without CHO condition. In this cell switch trigger, there may be RRC parameters containing all information for PHY and MAC of the target cell. To simplify the interface, this command may contain pre-configured “config-group ID” and config index which may point to the RRC parameters containing all information for PHY and MAC of the target cell.

For example, step 915: Upon applying all the configuration at the UE side, UE may send an RRCReconfigComplete to DU/RRC-L.

For example, step 916: UE is connected to cell 2.

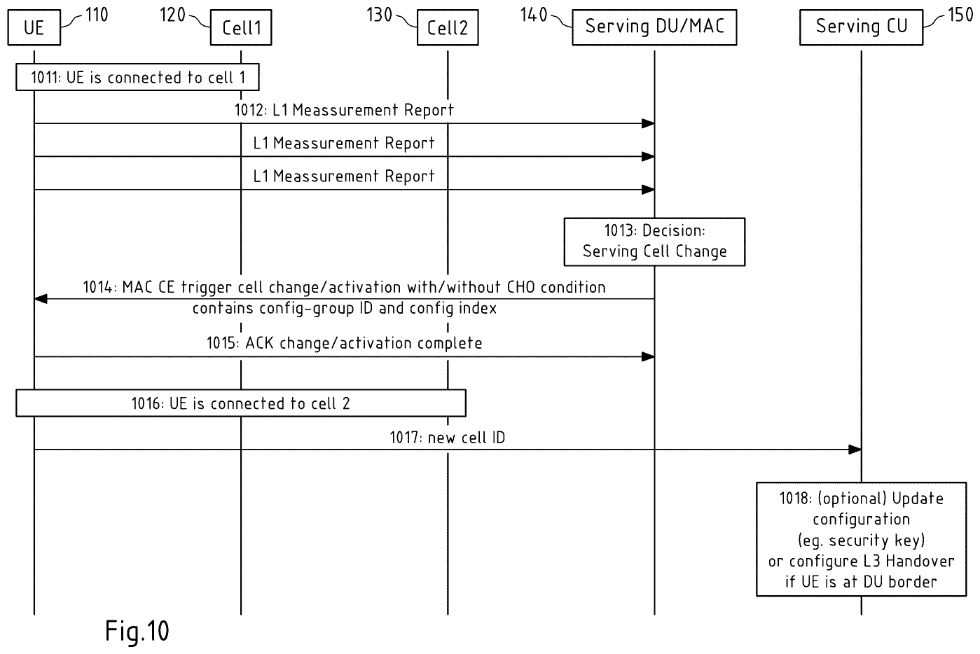

FIG. 10 shows an example message sequence chart showing an example of a method according to the fourth, fifth, and sixth example aspect. In this example, in step 1012 UE 110 may transmit, to DU 140, at least one measurement report (e.g. layer 1 measurement report), DU 140 providing a serving cell 120 and a target cell 130 for UE 110, wherein the serving cell 120 and the target cell 130 share at least a protocol configuration of a radio resource control layer. In step 1013, DU 140 determines, based on the at least one measurement report, whether UE 110 is to perform a handover to the target cell 130. In step 1014, DU 140 transmits, based on determining that UE 110 is to perform the handover, to UE 110 an indication of a handover configuration for a handover of UE 110 to the target cell 130, the indication of the handover being comprised in a MAC CE trigger for cell change/activation with or without CHO condition. UE 110 may perform, based on receiving the indication of the handover configuration, the handover according to the handover configuration. In step 1015, UE 110 transmits a completion indicator indicating completion of the handover. In step 1017, UE 110 transmits to CU 150, a cell indicator indicating the target cell 130. In step 1018, CU 150 determines to perform a cell action (such as a security key update or determining a handover configuration for a layer 3 handover) based on the cell indicator.

The example of FIG. 10 may relate to baseline mobility for single RRC and may illustrate mobility within DU using the disclosed architecture. For example:

For example, step 1011: UE is at first connected to cell 1 (e.g. serving cell).

For example, step 1012: Any measurements that may be sent to DU MAC sublayer may be defined as L1 measurement sent (e.g. transmit at least one measurement report). The UE beam that is used for the measurement may be indicated in the report. These measurement reports may be sent to DU MAC sublayer from UE.

For example, step 1013: Upon receiving the measurement report, DU MAC sublayer may make the decision to switch cell.

For example, step 1014: E.g. in single RRC, DU may send MAC-CE cell switch command. In this cell switch trigger, there may be RRC parameters (e.g. handover parameters) containing all necessary information for PHY and MAC of the target cell. To simplify the interface, this command may contain pre-configured “config-group ID” (e.g. indication of a configuration group) and config index (e.g. a configuration index) which may point to the RRC parameters containing all necessary information for PHY and MAC of the target cell.

For example, step 1015: Upon applying all the necessary configuration at the UE side, UE may send an optional acknowledgement e.g. in single RRC case.

For example, step 1016: UE is now connected to cell 2.

For example, step 1017: UE inform CU about the new cell ID. Thus, in the example of FIG. 10, the UE may be configured to inform higher layer about the new cell ID.

For example, step 1018 The CU may use the new cell ID for statistics for network optimizations. Upon receiving the cell ID, it may trigger security key updates. It may trigger L3 HO if UE is at DU border. According to an example, DU may detect (or determine) if UE is at DU border, and enable the indication [DU border: true](e.g. border indication) to RRC layer. A L3 HO may be event triggered if the measurement satisfied the condition, an L3 report may be sent to CU, and CU may trigger a L3 HO. Upon receiving the cell ID and [DU border: true] from DU, based on the L3 measurement report, CU may trigger L3 HO to UE. By knowing the UE is at the cell border, may help CU prioritize L3 handover over cell at MAC handover.

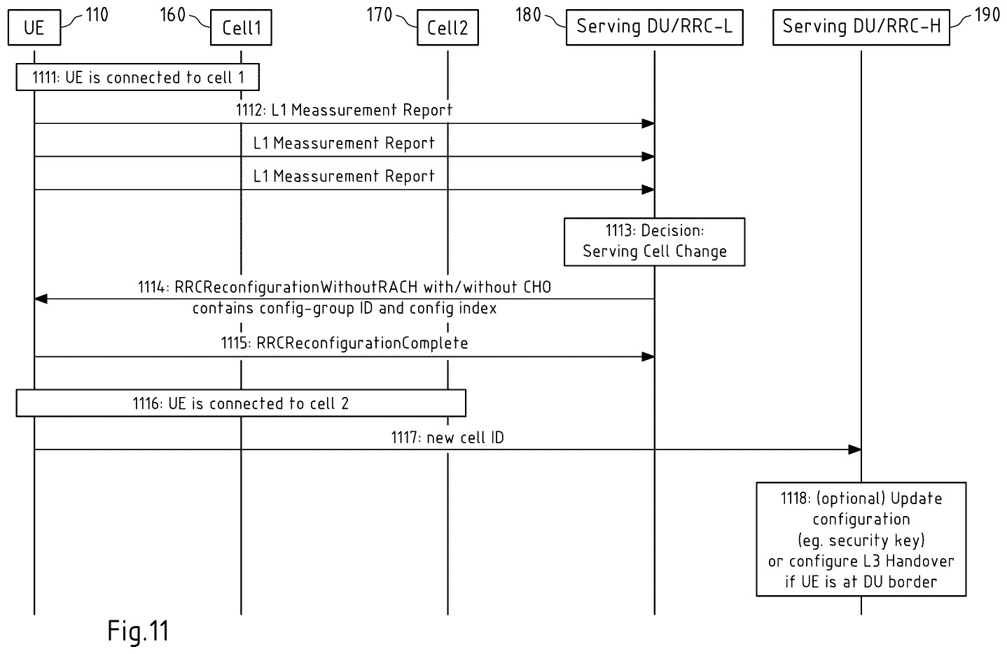

FIG. 11 shows an example message sequence chart showing an example of a method according to the fourth, fifth, and sixth example aspect. In this example, in step 1112 UE 110 may transmit to DU 180, at least one measurement report (e.g. layer 1 measurement report), DU 180 providing a serving cell 160 and a target cell 170 for UE 110, wherein the serving cell 160 and the target cell 170 share at least a protocol configuration of a radio resource control (denoted RRC-H) layer, e.g. the serving cell 160 and target cell 180 share RRC-H. DU 180 being a DU configured with a mobility radio resource control (denoted RRC-L) layer. In step 1113, DU 180 determines, based on the at least one measurement report, whether UE 110 is to perform a handover to the target cell 170. In step 1114, DU 180 transmits, based on determining that UE 110 is to perform the handover, to UE 110 an indication of a handover configuration for a handover of UE 110 to the target cell 170, the indication of the handover being comprised in an RRCReconfiguration message without RACH and with or without a CHO condition. UE 110 may perform, based on receiving the indication of the handover configuration, the handover according to the handover configuration. In step 1115, UE 110 transmits a completion indicator indicating completion of the handover, the completion indicator e.g. being RRCReconfiguration complete. In step 1117, UE 110 transmits to CU 190, a cell indicator indicating the target cell 170. In step 1118, CU 190 determines to perform a cell action (such as a security key update or determining a handover configuration for a layer 3 handover) based on the cell indicator.

The example of FIG. 11 may relate to baseline mobility for dual RRC. For example:

For example, step 1111: UE is at first connected to cell 1.

For example, step 1112: Any measurements that may be sent to DU RRC-L may be defined as L1 measurement. The UE beam that is used for the measurement may be indicated in the report. These measurement reports may be sent to RRC-L sublayer from UE.

For example, step 1113: Upon receiving the measurement report, RRC-L sublayer may make the decision to switch cell.

For example, step 1114: E.g. in dual RRC case, RRC-L may send a RRC command “RRCReconfigurationWithoutRACH” to UE with or without CHO condition. In this cell switch trigger, there may be RRC parameters (e.g. handover parameters) containing all necessary information for PHY and MAC of the new target cell. To simplify the interface, this command may contain pre-configured “config-group ID” and config index which may point to the RRC parameters containing all necessary information for PHY and MAC of the new target cell.

For example, step 1115: Upon applying all the necessary configuration at the UE side, UE may send an RRCReconfigComplete to DU/RRC-L in dual RRC case.

For example, step 1116: UE is now connected to cell 2.

For example, step 1117: UE may inform RRC-H about the new cell ID. Thus, in the example of FIG. 11, the UE may be configured to inform higher layer about the new cell ID.

For example, step 1118 The RRC-H may use the new cell ID for statistics for network optimizations. Upon receiving the new cell ID, it may trigger security key updates. It may trigger L3 HO if UE is at DU border. A L3 HO may be event triggered if the measurement satisfied the condition, an L3 report may be sent to RRC-H, and RRC-H may trigger a L3 HO. DU may detect (or determine) if UE is at DU border, and RRC-L may enable the indication [DU border: true](e.g. border indication) to RRC-H. Upon receiving the new cell ID and [DU border: true] from RRC-L, based on the L3 measurement report, RRC-H may trigger L3 HO to UE. By knowing the UE is at the cell border, may help RRC-H prioritize L3 handover over cell at MAC handover.

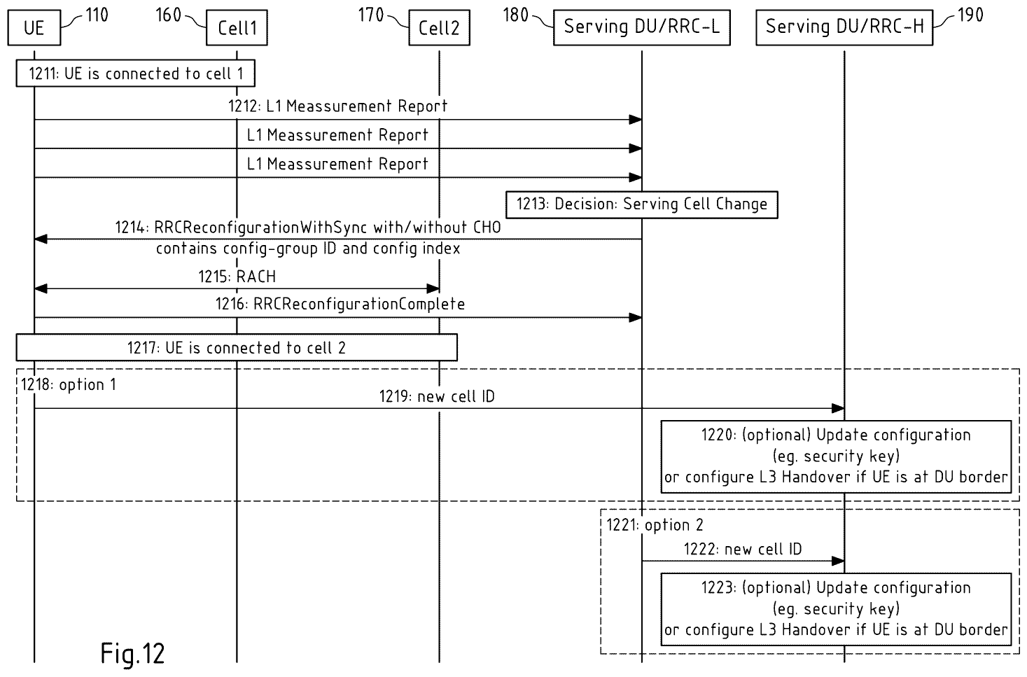

FIG. 12 shows an example message sequence chart showing an example of a method according to the fourth, fifth, and sixth example aspect. In this example, in step 1212 UE 110 may transmit to DU 180, at least one measurement report (e.g. layer 1 measurement report), DU 180 providing a serving cell 160 and a target cell 170 for UE 110, wherein the serving cell 160 and the target cell 170 share at least a protocol configuration of a radio resource control (denoted RRC-H) layer, e.g. the serving cell 160 and target cell 180 share RRC-H. DU 180 being a DU configured with a mobility radio resource control (denoted RRC-L) layer. In steps 1213, DU 180 determines, based on the at least one measurement report, whether UE 110 is to perform a handover to the target cell 170. In step 1214, DU 180 transmits, based on determining that UE 110 is to perform the handover, an indication of a handover configuration for a handover of UE 110 to the target cell 170. The indication of the handover may be comprised in an RRCReconfiguration message. The RRC reconfiguration may be, for example, RRCReconfiguration with sync and with or without a CHO condition. In step 1215, UE 110 may perform, based on receiving the RRCReconfiguration message with sync comprising the indication of the handover configuration, a random access channel (RACH) process with the target cell 170, to perform the handover according to the handover configuration. In step 1216, UE 110 transmits a completion indicator indicating completion of the RACH process or handover, the completion indicator e.g. being RRCReconfiguration complete. In step 1219, UE 110 may e.g. transmit a cell indicator indicating a target cell to the DU/RRC-H. Alternatively or additionally in step 1222 DU 180 may e.g. transmit a/the cell indicator indicating a/the target cell to the DU/RRC-H. In step 1220 or alternatively/additionally (1218, 1221) in step 1223, CU 190 determines to perform a cell action (such as a security key update or determining a handover configuration for a layer 3 handover) based on the cell indicator.

The example of FIG. 12 may relate to baseline mobility for dual RRC. For example, illustrating that RRC-L may also trigger RACH for handover, the disclosed architecture may allow the update of cell ID to CU from DU or UE, which may enable a decoupled security key update or decoupled re-establishment of PDCP, RLC layer.

The following example (in particular with respect to the method according to any aspect) is also disclosed:

Serving DU triggers the cell change via a new MAC CE containing updated parameters only related to PHY and MAC. With single RRC and dual RRC option Serving DU forwards the new cell ID IE to CU. With UE option, the cell ID is forwarded by the UE to higher layers. Serving CU decides to trigger PDCP re-establishment, update the security key or to configure L3 handover.

The following example (in particular with respect to the method according to any aspect) is also disclosed:
For each UE, one RRC entity is created for current serving cell setting up all parameters for PDPC, RLC, MAC and PHY.
When UE is moving across cells within a DU, the change of serving cell is activated by MAC-CE based on the measurement report DU receives.
Instead of reconfiguration of whole set, such trigger may comprise, e.g. only comprise, updated parameters related to PHY and MAC. (delta reconfiguration)
Upon completion of HO, DU sends an indication about the new cell ID that UE is handed over to the RRC layer.
Such indication results a PDCP re-establishment, such that a new security key is generated.

This example may pertain to single RRC, dual RRC, or UE driven.

### Example 1. Single RRC at CU

When UE is moving across cells within a DU, based on receiving measurement reports at DU, the change of serving cell may be activated by MAC-CE containing the updated parameters related to MAC and PHY layer.

Upon the completion of handover, which may be marked by UE sending back an acknowledgement, MAC layer at the DU may inform the RRC layer at CU about the new cell ID. RRC may then decide if it shall trigger the upper layers a PDCP re-establishment, to generate a new security key.

### Example 2. Dual RRC (RRC Split: RRC-H at CU, RRC-L at DU)

When UE is moving across cells within a DU, based on receiving measurement report at DU RRC-L, the change of serving cell may be activated by RRC reconfiguration command containing the updated parameters related to MAC and PHY layer and it may be managed by RRC-L.

Upon the completion of handover, which may be marked by UE sending back an acknowledgement RRCReconfigurationComplete, RRC-L may inform RRC-H about the new cell ID. RRC-H may then decide if it shall trigger the upper layers a PDCP re-establishment, to generate a new security key.

In addition, the described steps may e.g. be based on a condition (e.g. report condition), for instance that the new cell is part of a group of cells.

### Example 3. UE Informs Higher Layer

Both in case of single and dual RRC, UE may inform CU about the new cell ID.

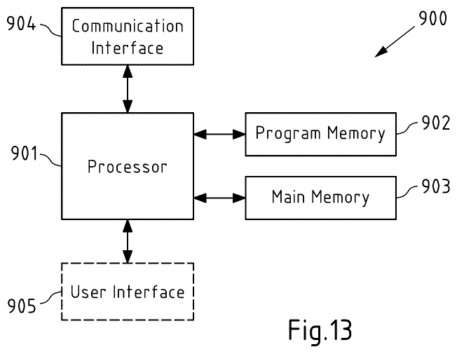

FIG. 13 is a schematic block diagram of an example embodiment of an apparatus according to the first aspect and/or an example embodiment of distributed unit of a network entity according to the second aspect and/or an example embodiment of central unit of a network entity according to the third example aspect.

Apparatus, distributed unit, or central unit 900 comprises a processor 901, program memory 902, working or main memory 903, data memory, communication interface(s) 904, and an optional user interface 905.

Apparatus, distributed unit, or central unit 900 may for instance be configured to perform and/or control or comprise respective means (at least one of 901 to 905) for performing and/or controlling the method according to the fourth, fifth and/or sixth example aspect. Apparatus, distributed unit, or central unit 900 may as well constitute an apparatus, distributed unit, or central unit comprising at least one processor (901) and at least one memory (902) storing instructions that, when executed by the at least one processor, cause an apparatus or network entity, e.g. apparatus, distributed unit, or central unit 900 at least to perform and/or control the method according to all (respective) example aspects.

Processor 901 may for instance further control the memories 902 to 903, the communication interface(s) 904, the optional user interface 905.

Processor 901 may for instance execute program code stored in program memory 902, which may for instance represent a readable storage medium comprising program code that, when executed by processor 901, causes the processor 901 to perform the method according to the fourth, fifth or sixth example aspect.

Processor 901 (and also any other processor mentioned in this specification) may be a processor of any suitable type. Processor 901 may comprise but is not limited to one or more microprocessor(s), one or more processor(s) with accompanying one or more digital signal processor(s), one or more processor(s) without accompanying digital signal processor(s), one or more special-purpose computer chips, one or more field-programmable gate array(s) (FPGA(s)), one or more controller(s), one or more application-specific integrated circuit(s) (ASIC(s)), or one or more computer(s)/server(s). The relevant structure/hardware has been programmed in such a way to carry out the described function. Processor 1001 may for instance be an application processor that runs an operating system.

Program memory 902 may also be included into processor 901. This memory may for instance be fixedly connected to processor 901, or be at least partially removable from processor 901, for instance in the form of a memory card or stick. Program memory 902 may for instance be non-volatile memory. It may for instance be a FLASH memory (or a part thereof), any of a ROM, PROM, EPROM and EEPROM memory (or a part thereof) or a hard disc (or a part thereof), to name but a few examples. Program memory 902 may also comprise an operating system for processor 901. Program memory 902 may also comprise a firmware for apparatus or network entity 900.

Communication interface(s) 904 enable apparatus or network entity 900 to communicate with other entities, e.g. another apparatus or network entity. The communication interface(s) 904 may for instance comprise a wireless interface, e.g. a cellular radio communication interface and/or a WLAN interface) and/or wire-bound interface, e.g. an IP-based interface, for instance to communicate with entities via the Internet. Communication interface(s) may enable apparatus or network entity 900 to communicate with other entities, for instance one or more entities as comprised in a mobile communication network.

User interface 905 is optional and may comprise a display for displaying information to a user and/or an input device (e.g. a keyboard, keypad, touchpad, mouse, etc.) for receiving information from a user.

Some or all of the components of the apparatus or network entity 900 may for instance be connected via a bus. Some or all of the components of the apparatus or network entity 900 may for instance be combined into one or more modules.

An apparatus 900 may further comprise at least one of the following: a receiver, e.g. for receiving an indication of a handover configuration for a handover of the apparatus to the target cell; a transmitter e.g. for transmitting at least one measurement report; a determiner, e.g. for determining whether the handover was completed; a re-establisher; or a performer.

A distributed unit 900 may further comprise at least one of the following: a provider e.g. for a serving cell and a target cell for an apparatus; a transmitter e.g. for transmitting an indication of a handover configuration for a handover of the apparatus to the target cell; a determiner e.g. for determining whether the apparatus is to perform a handover to the target cell; or a receiver e.g. for receiving at least one measurement report.

A central unit 900 may further comprise at least one of the following: a receiver, e.g. for receiving a cell indicator indicating a target cell; a determiner e.g. for determining to perform a cell action; or a transmitter e.g. for transmitting a key indication.

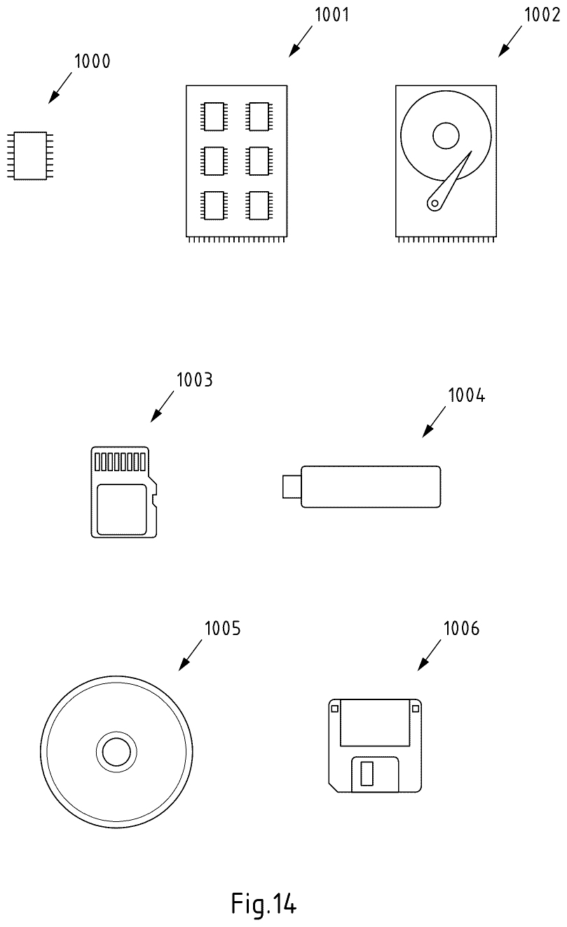

FIG. 14 is a schematic illustration of examples of (tangible and/or non-transitory) computer-readable storage media according to the present disclosure that may for instance be used to implement memory 902 or memory 903 of FIG. 13. To this end, FIG. 14 displays a flash memory 1000, which may for instance be soldered or bonded to a printed circuit board, a solid-state drive 1001 comprising a plurality of memory chips (e.g. Flash memory chips), a magnetic hard drive 1002, a Secure Digital (SD) card 1003, a Universal Serial Bus (USB) memory stick 1004, an optical storage medium 1005 (such as for instance a CD-ROM or DVD) and a magnetic storage medium 1006.

In the present specification, any presented connection in the described embodiments is to be understood in a way that the involved components are operationally coupled. Thus, the connections can be direct or indirect with any number or combination of intervening elements, and there may be merely a functional relationship between the components.

Moreover, any of the methods, processes and actions described or illustrated herein may be implemented using executable instructions in a general-purpose or special-purpose processor and stored on a computer-readable storage medium (e.g., disk, memory, or the like) to be executed by such a processor. References to a ‘computer-readable storage medium’ should be understood to encompass specialized circuits such as FPGAs, ASICs, signal processing devices, and other devices.

The expression “A and/or B” is considered to comprise any one of the following three scenarios: (i) A, (ii) B, (iii) A and B. Furthermore, the article “a” is not to be understood as “one”, i.e. use of the expression “an element” does not preclude that also further elements are present. The term “comprising” is to be understood in an open sense, i.e. in a way that an object that “comprises an element A” may also comprise further elements in addition to element A. Further, the term “comprising” may be limited to “consisting of”, i.e. consisting of only the specified elements.

The expression “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

It will be understood that all presented embodiments are only examples, and that any feature presented for a particular example embodiment may be used with any aspect on its own or in combination with any feature presented for the same or another particular example embodiment and/or in combination with any other feature not mentioned. In particular, the example embodiments presented in this specification shall also be understood to be disclosed in all possible combinations with each other, as far as it is technically reasonable and the example embodiments are not alternatives with respect to each other. It will further be understood that any feature presented for an example embodiment in a particular category (method/apparatus/computer program/system) may also be used in a corresponding manner in an example embodiment of any other category. It should also be understood that presence of a feature in the presented example embodiments shall not necessarily mean that this feature forms an essential feature and cannot be omitted or substituted.

The statement of a feature comprises at least one of the subsequently enumerated features is not mandatory in the way that the feature comprises all subsequently enumerated features, or at least one feature of the plurality of the subsequently enumerated features. Also, a selection of the enumerated features in any combination or a selection of only one of the enumerated features is possible. The specific combination of all subsequently enumerated features may as well be considered. Also, a plurality of only one of the enumerated features may be possible.

The sequence of all method steps presented above is not mandatory, also alternative sequences may be possible. Nevertheless, the specific sequence of method steps exemplarily shown in the drawings shall be considered as one possible sequence of method steps for the respective embodiment described by the respective drawing.

The subject-matter has been described above by means of examples. It should be noted that there are alternative ways and variations which are obvious to a skilled person in the art and can be implemented without deviating from the scope of the appended claims.

### LIST OF ABBREVIATIONS

3GPP Third Generation Partnership Project
5G 5-th Generation
AM acknowledge mode
BS Base Station
CA Carrier Aggregation
CU central unit
DL Downlink
dMIMO distributed multi-input-multi-output
DU distributed unit
DRB data radio bearer
EHC Ethernet Header Compression
gNB next generation NodeB
ICBM Inter-cell beam management
IP Internet Protocol
L1 layer 1
L2 layer 2
L3 layer 3
MAC Medium/Media Access Control
MIMO Multiple Input Multiple Output
NR New Radio
PDCP Packet Data Convergence Protocol
PDSCH Physical Downlink shared data channel
PUSCH Physical Uplink shared data channel
RACH Random Access Channel
RAN Radio Access Network
RF Radio Frequency
ROHC Robust Header Compression
RLC Radio Link Control
RRC Radio Resource Control
SDAP Service Data Adaptation Protocol
SDU Service Data Unit
SRB Signal Radio Bearer
UDC Uplink Data Compression
UE User Equipment
UL Uplink
UM un-acknowledge mode

1. An apparatus comprising:
means for transmitting, to a network entity, at least one measurement report, the network entity providing a serving cell and a target cell for the apparatus, wherein the serving cell and the target cell share at least a protocol configuration of a radio resource control layer;
means for receiving, from the network entity, an indication of a handover configuration for a handover of the apparatus to the target cell;
means for performing, based on receiving the indication of the handover configuration, the handover according to the handover configuration.

2.-70. (canceled)
